(19) United States
(12) Patent Application Publication
(10) Pub. No.: US 2007/0028019 A1
(43) Pub. Date: Feb. 1, 2007

(54) Method and apparatus for efficient text entry in cell phones and other small keypad devices

(76) Inventor: Millind Mittal, Palo Alto, CA (US)

Correspondence Address: TRAN & ASSOCIATES, 6768 MEADOW VISTA CT., SAN JOSE, CA, 95135, US

(21) Appl. No.: 11/230,242

(22) Filed: Sep. 19, 2005

Related U.S. Application Data
(60) Provisional application No. 60/702,917, filed on Jul. 27, 2005.

(51) Int. Cl. G06F 13/38; G06F 13/12

(52) U.S. Cl. 710/73

(57) ABSTRACT

Systems and methods are disclosed for entering data into a keypad having a plurality of keys, each key used to select one character from at least first, second and third characters designated for each key. The method includes providing disambiguation information on a current key and subsequently selecting a next key covering a desired character. In another aspect, for the keyboards where touching and key, and subsequent untouching or pressing a key are taken as two separate events. In this case the disambiguation information is provided by key touched immediately prior to the key pressed or untouched. In yet another method where the touching of a key when there was no prior touched key (first-touch key), and touching a new key without untouching the keypad are taken as two separate events, the first-touch key is taken as a selection of key with one of the desired characters, and a subsequent touching of an adjacent key without untouching of the keypad is used to index and select the characters on the selected key.

The present application claims priority to Provisional Application Ser. No. 60/702,917 filed on Jul. 27, 2005, the content of which is incorporated by reference.

### BACKGROUND OF THE INVENTION

The present invention relates to providing a user friendly small keypad layout for inputting text.

There is a growing trends towards utilizing small factor devices like cell phones or PDAs for usages beyond phone calls, and simple text messaging. More and more need is towards using these devices as versatile emailing and messaging devices. Use of cell phones and PDAs as email and messaging devices presents a critical need to have a convenient form of inputting text while keeping the keypad size still small. Today's schemes for inputting text in small form factor devices like cells phones, and PDAs consist of primarily two types which are shown in FIG. 1 and FIG. 2.

FIG. 1 shows an exemplary 4 row×3 column matrix used in most cell phones. In this format Row 1, Column 2 (represented as R1-C2) covers 4 values in text mode—a, b and c and 2. Similarly R2-C2 is used to type four different values j, k, l and 5. There are different methods used for selection of a characters out of multiple characters represented by a key. The common method used is what is referred to as Multi-press Method. The number of times a key is pressed in quick succession determines which character is selected.

In this system the selection of which of the character is taken as the input is made by how many time in succession a key is pressed. If the key is pressed once, it represents j. If the key is pressed twice in quick succession, i.e. within a pre-selected time interval, it represents k, and so on. If the key is not pressed within the selected time interval, the cursor is moved to the next character. Typically, the succession interval is quite small to speed up the typing rate. However, a small succession interval leads to mistakes of pressing a key too many times, or not pressing quick enough. Also, in certain touch sensitive keypads, instead of pressing the key for inputting, there is a sensor at the key location that senses the touch of the key. In this case touching of a key is taken similar to pressing of a key.

The advantage of multi-press method is that the thumb/finger movement is minimized, but the user needs to become proficient at timing the key pressing and at pressing a key correct number of times to output a character. Also, since the input is sensitive to the number of presses, and time interval between the presses, this scheme inherently limits the speed of typing.

For cell phone keypads such as those shown in FIG. 1, another, albeit not common, data entry methods include a two-key entry scheme: In this scheme, alphabets are encoded in combination of two keys. For example, “b” is encoded as pressing key at Row 1-column 2 (here it is notated as R1-C2) followed by Row 4- Column 2 (R4-C2). Other combinations are also possible. In this method key with multiple characters is selected first, which provides ambiguous entry first, it is then followed by a second key that provides index (position) of the chosen character from the list of characters first key. One limitation of this scheme is excessive movement of the thumb/finger and bending of the thumb/finger, which leads to fatigue and which slows down data entry speed. The advantage of this scheme is that the error rate is reduced as selection is only a function of the keys pressed and not the time interval between the pressings of the keys.

FIG. 2 shows a keyboard with a full QWERTY layout for PDAs and other portable devices. However, as there is insufficient space, each key size is reduced to a tiny size, and using the keypad becomes either inconvenient or error prone. Other schemes include obviating the time-out part of the multi-press method by having an explicit key to be pressed to move the cursor to the next character. In yet other keypads for mobile devices, each key is capable of sensing pressure in eight different directions (North, East, South, West, North East, South East, North West, and South West). In this case, a pressure sensing key is needed.

The foregoing methods can generally be classified as Select-and-Disambiguate (SD) methods. In these, first a key with multiple characters on it, is selected, and then a second action is taken to disambiguate between the selected set.

### BRIEF SUMMARY OF THE INVENTION

Systems and methods are disclosed for entering data into a keypad having a plurality of keys, each key used to select one character from at least first, second and third characters designated for each key. The method includes providing disambiguation information on a current key and subsequently selecting a next key covering a desired character.

Implementations of the above system and method may include one or more of the following. The disambiguation information can be provided through multiple presses of the current key. A lack of additional pressing of the current key implies a first character from the next key is selected. The method includes pressing the current key once to select a second character from the next key. The current key can be pressed twice to select the third character from the next key. The current key can be pressed thrice to select a fourth character from the next key. A key not belonging to the set of keys with a character-set can provide disambiguation information where the next key is the same as the current key. Upon pressing the next key, the system can provide a selected character and move a cursor to a new display position. The system can detect a key stroke indicating repetition of the previous character. Data entry can be received from a touch keypad capable of distinguishing between touching and pressing/entering of a key. The keypad has touch-sensing and key press detection capability. The keypad may have ability to differentiate between initial touch and untouching of a key. In this case, removing a touch (un-touching) can be taken as the pressing of the key. The touching and un-touching can be two distinct events. A key touch followed by pressing/un-touching of another key indicates the character to be taken from the key that is pressed/untouched. The system includes touching a key and moving in a horizontal or vertical line prior to pressing or untouching a subsequent key to select a second character associated with the subsequent key. The system also includes touching a key and moving in a diagonal line prior to pressing or untouching a subsequent key to select a third character associated with the subsequent key. If the key is R4-C1 key and the subsequent pressed or untouched key is R3-C1 key, the system can select the fourth character associated with the R3-C1 key. Similarly, if the key is R4-C3 key and the subsequent pressed or untouched key is R3-C3 key, the system can select the fourth character associated with the R3-C3 key. The system can distinguish and differentiate up to eight possible keys that can be touched prior to or after pressing or untouching a selection key. As an example, touch of key R2-C1 followed by press/untouch of key R2-C2, indicates character “k” is chosen. The above methods are in defined as Disambiguate-Select (DS) method, since Disambiguation is done prior to selecting the key with multiple characters with one of the characters being the character to be chosen. As outlined above, further there are multiple types of entry systems using DS possible. Specifically, one system specified is the system where disambiguation is done based on multiple pressing of the current or disambiguation keys. This system is referred to as Disambiguate-Select-Multi-Press (DS-MP) system. Second system is a system where keypad, in addition of sensing “pressing” of a key, can sense “touching” of a key. In this case, “touch” of a key prior to the pressed key provides the disambiguation information, while pressed key is taken as the selection key. Such a system is referred to as Disambiguate-Select-Touch-Press (DS-TP) system. A system where “untouching” is equivalent to “pressing” is referred to as Disambiguate-Select-Touch-Untouch (DS-TU) system.

In implementations where the touch sensing keyboard can record touching and un-touching as two distinct events, yet another scheme that does not involve introducing time-outs to control move of the cursor to the next character, is presented where touching of a key is taken as a selection of the key with multiple character choices, and the disambiguation is done by sliding the contact to (i.e. touching without removing contact) an adjacent key without untouching. In this scheme selection is done prior to disambiguation. This system is referred to as Select-Disambiguate-Touch-Untouch (SD-TU) system.

In another aspect, in an SD-TU system where the touching of a key when there was no prior touched key (first-touch key), and touching a new key without untouching the keypad are taken as two separate events, the first-touch key is taken as a selection of key with one of the desired characters, and a subsequent touching of an adjacent key without untouching of the keypad is used to index and select the characters on the selected key.

In implementations of the SD-TU system, the untouching without touching an adjacent key is taken to select the first character of the select key. The touching a key when there was no prior key touched, the Select key, and then moving in a horizontal or vertical line to the an adjacent key without untouching the keypad selects a second character associated with the Select key. The touching a key when there was no prior key touched, the Select key, and then moving in a diagonal line to the an adjacent key without untouching the keypad selects a third character associated with the Select key. The touching of the first key touched prior to any other key on the keypad is R4-C1 key and wherein the subsequent key touched, without untouching the keypad is R3-C1 key, selects the fourth character associated with the R3-C1 key. Where the first key touched prior to any other key on the keypad is R4-C3 key and where the subsequent key touched, without untouching the keypad is R3-C3 key, the system selects the fourth character associated with the R3-C3 key. The system can also differentiate one of eight possible keys that can be touched after a selection key.

All of the above mentioned four systems do not have a time-out notion, and in most cases do not require pressing any addition keys to move to the next character. Thus they minimize any additional thumb/finger movement. The methods improves significantly inputting of text using the standard 4 rows×3 column matrix layout on the cell phones. The scheme also lends itself to evolving the keypad of cell phones to different layouts, while still allowing convenient inputting of the text with only a small number of keys. The scheme is well suited for working with both the standard pressure sensitive keypads as well as touch keypads. The format conforms to the standard cell phone keypad layout. Invention provides some specific ways of combining the proposed key-encoding, and hand/thumb sliding over a touch keypad to enable efficient text entry. The same concepts can be further used for new input keypads with various keys to facilitate inputting of text.

Other advantages may include one or more of the following. The system provides a key entry scheme for standard 12 button layout of cell phones to provide a more intuitive and convenient method for inputting text. The system minimizes the need to have to look at the screen and the keyboard at the same time while typing by making the key pressing unambiguous. This is similar to the standard computer keyboard. It is difficult for the user to look at the keypad and screen at the same time. The user can focus on the keypad while typing, or if he/she is proficient in the movement of thumb/finger to appropriate key, then the user can focus on the screen to catch errors. This means the emphasis should be placed on minimizing chances of input error. Further, the system eliminates the need to have time-out driven inputting. This requires the user to constantly look at the screen to see whether the timeout has occurred, and it is safe to move on, also it forces a user to maintain a momentum in typing, and not slow-down or speed-up as he/she feels comfortable. The system keeps the number of keys in the keypad small, thus allowing cell phones with fewer, but larger keys in the keypad so that the chances of error in pressing the wrong key are minimized. The system also minimizes the cases where thumb/finger has to be moved to a new key just to disambiguate the chosen character from a list of characters represented by a key. Also, minimize the cases where the key has to be pressed multiple times. Such a small keypad is ideal for mobile devices like mobile phones and Personal Digital Assistants (PDAs).

### BRIEF DESCRIPTION OF THE DRAWINGS

FIG. 1 shows an exemplary 4 row×3 column layout of a cell phone.

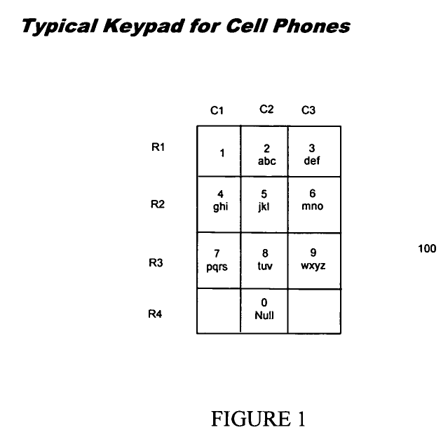

FIG. 2 shows an exemplary QWERTY keyboard.

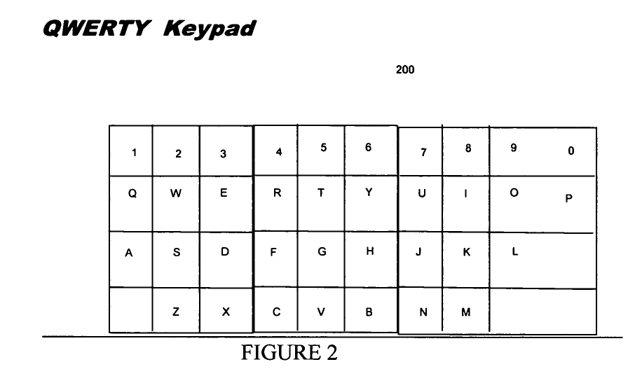

FIG. 3 shows exemplary key strokes for the keyboard of FIG. 1 with a DS-MP (Disambiguate-Select-Multi-Press) system.

FIG. 4 shows a state machine diagram for the DS-MP system of FIG. 3.

FIG. 5 shows exemplary key strokes for the keyboard of FIG. 1 with a DS-TP (Disambiguate-Select-Touch-Press) or a DS-TU (Disambiguate-Select-Touch-Untouch) system.

FIG. 6 shows state machine diagram for DS-TP system of FIG. 5.

FIG. 7 shows state machine diagram for DS-TU system of FIG. 5.

FIG. 8 shows state-machine diagram for the keyboard of FIG. 1 with an SD-TU (Select-Disambiguate-Touch-Untouch) system.

### DETAILED DESCRIPTION OF THE INVENTION

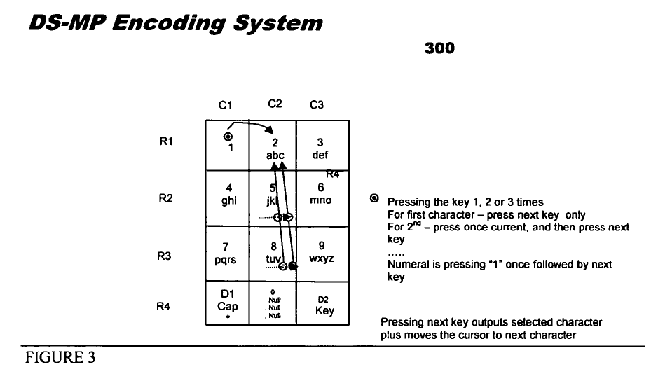

FIGS. 3-7 show various embodiments of a data entry method called the Disambiguate-and-Select (DS) method. In this method, an action provides disambiguation information is then followed by selection of the key with multiple characters. The systems use standard 4 row×3 column layout of existing cell phones, but is more user friendly to input text in the text mode. This is accomplished in part by removing the time sensitivity aspect from the determination of the character being input.

In the DS method to disambiguate-and-select-key system for entering text, the disambiguation information is provided prior to selection of the next key which covers the desirable alphabet. The disambiguation information may be provided by multiple presses of the current key and can be characterized as follows:
1. a lack of additional pressing of the current key implies first character from the next key is selected
2. pressing current key once, implies second character from the next key is selected
3. pressing current key twice, implies third character from the next key is selected
4. pressing current key three, implies fourth character from the next key is selected and other sequences can be used.
5. where the next key is same as the current key, one or more keys external to the set of keys that provide characters-set can be used to provide disambiguation information.
6. pressing next key provides the desired (selected character), and it moves the cursor to the next character.
7. a key stroke can also be defined to indicate repetition of the previous character.

In this system, the meaning of any diagonal key touching, as well as most horizontal and vertical keys touching is preserved. Moreover, the system can differentiate between up to 8 possible keys that can be touched prior to of after the key that is used for selection purpose. The system can also handle touching of more than one key before or after the selection key.

FIG. 3 shows one embodiment of the DS method. In this method, instead of selecting a key containing the character of interest, and then disambiguating the character by either multiple presses, or by pressing another key, the process is reversed. First, a disambiguation key is selected, and then the key with desired character is pressed. The pressing of the key with the desired character (the selection step) has two effects: it provides the selection of the group of characters, and then moves the cursor to the next character. The disambiguation key, along with the number of times it is pressed, is a function of the key's current state and the next character. In most cases, the disambiguation key is the current key. There is a separate disambiguation key also defined. As a disambiguation key (the new key or the current key after the selection phase) is pressed repeatedly, it sequences through the possible position values 1, 2 and 3. Here is description of how various cases are covered for the text entry mode:
a. Numbers are always R1-C1 followed by the key with the desired numeral value. E.g. 5 is R1-C1/R2-C2 (Here “/” stands for “followed by”)
b. Since along with “null” character, other commonly use characters are “.” And “,”, these are defined by the same key as “null” character, which is R4-C2. Note that this is not essential to the DS method, but it is deemed to lead to more user friendly interface. So now, R4-C2 represents “0”, “null”, “.'null” (“.” concatenated with null character), and “,'null” (“,” concatenated with the null character).
c. One stroke of R4-C1 is also redefined as follows:
   i. Disambiguation Key 1 (D1-Key)-Represented by one pressing of R4-C1. This allows faster entry for the cases when the next key is same as the current key, and the character to be selected is the first character from the key.
   ii. Capitalization encoding. This was earlier represented by R4-C3. Now R4-C3 is free for use for other purposes. R4-C3 is now free to additional cases of interest for disambiguation. R4-C3 is redefined as Disambiguate Key 2 (or D2-key). The purpose of the D2-Key is to allow convenient way of disambiguation of the position for the cases where it is not possible to do so by the current key. The case arises when two consecutive characters belong to the same Alphabet key. Also, D2-key is used to select 2^{nd} and 3^{nd} encodings of R4-C1. This technique can be used for other cases as well where it is still possible to disambiguate with the current key. The disambiguation strokes wraparound after 3. Also, the D2-key could also be used to cover the case when the next key is same as the current key, and the character to be selected is the first character, i.e the case c(i). D1-Key is defined just as a matter of convenience. Capitalization is selected by R4-C3/R4-C1 sequence (this is the second choice of R4-C1).
   iii. R4-C3/R4-C3/R4-C1 represents all other current encoding of the R4-C1
d. Behavior of all keys with respect to their overloading for disambiguation for the next key, is same, except R4-C1 and R4-C3 (the new D2-Key). Pressing R4-C1 once selects first character of the next key as the next character. R4-C3/R4-C1 selects capitalization, and R4-C3/R4-C3/R4-C1 selects other special character options typically covered by R4-C1 in today's system. R4-C3 (D2-Key) is only used for creating disambiguation choice between 1, 2 and 3 (its value wraps around at 3). For all other keys there are two situations.
   i. There is no current key (initial state) or if next key is same as the current key
      1. If there is no current key, first character of the next key is chosen by pressing next key directly. E.g. R3-C2 is “t”. If next key is same as current key, the next character is chosen by pressing newly defined D1-key (R4-C1)
      2. Second alphabet in the next key is represented pressing newly defined D2-key (R4-C3), once and then next key. R4-C3/R3-C2 is “u”.”
      3. Third alphabet in the next key is represented by pressing newly defined D2-key (R4-C3), twice and then the next key.

R4-C3/R4-C3/R3-C2 is “u”.”
4. In some cases there are four alphabets in the Alphabet group. Fourth character is selected by is represented by pressing newly defined D2-key (R4-C3), thrice and then the next key. R4-C3/R4-C3/R4-C3/R3-C3 is “z”.
ii. If next key is not same as current key
   1. If it is the first character is selected by directly pressing the next key.
   2. If it is the second character is selected by pressing the current key once, and then the next key.
   3. If it is the third character is selected by pressing current key twice and then the next key.
   4. If it is the fourth character is selected by pressing the current key three times and then the next key.
e. Note that it is recognized that some keyboard may add one additional key, or allow for reuse of one of the control keys, for example key for selecting the call (typically the key with green telephone handset). This additional key could cover additional useful scenarios, for example, a Repeat key, which would indicate that the next character is same as the current character.

The scheme of FIG. 3 is advantageous in that it removes complications as a result of the time-out notion with multi-pressing mode, without requiring any additional finger or thumb movement in most cases. Since there is no time-out mode, the scheme becomes suitable of quick typing with two thumbs/fingers at a time.

The scheme that provides disambiguation information first, and then provides the Alphabet key containing the alphabet, has significant advantage for the keypads that allow for ability to distinguish the presence of finger/thumb above the key from pressing of the selected key.

For a normal touch keypad, where there is no distinction between the touch and pressing of the key, or between touching and un-touching of the key, the scheme works similar to way described in description for FIG. 3.

As mentioned earlier, desired keypad can also be implemented in a number of ways: 1) keypad where disambiguation is done based on multi-pressing—this is called Disambiguation-and-select-Multi-Press (DS-MP) system, and 2) keypad where keypad is able to differentiate between “touch” and “press” or between “touch” and “untouch”—this is called DS-Touch-Press (DS-TP), or DS-Touch-Untouch (DS-TU) system. Hence, multiple considerations can be used to develop an input device for inputting text.

In one embodiment, an Multi-press keypad scheme is implemented over a keypad is a touch keypad capable of distinguishing between touch and pressing/entering of the key. In this embodiment, either the keypad had touch sensing and key press detection capability, or the touch pad where removal of a touch (un-touching) is taken as the pressing of the key, and not touching.

In one embodiment, the touching of a key followed by pressing/un-touching of another key is taken to indicate the character to be taken from the key that is pressed/untouched. Example, touch of key 4 followed by press/untouch of key 5, indicates character “k” is choosen.

Any touching of the key located in a horizontal or vertical straight line prior to touching the key with the desired character, indicates the second character on the key. If the prior key is along the diagonal, then 3rd character is selected. For R3-C1 and R3-C3, there is an exception. For R3-C1, if the previous key touched is R4-C1, then the character selected is the fourth character. For R3-C3, if the previous key touched is R4-C3, then the character selected is the fourth character of R3-C3.

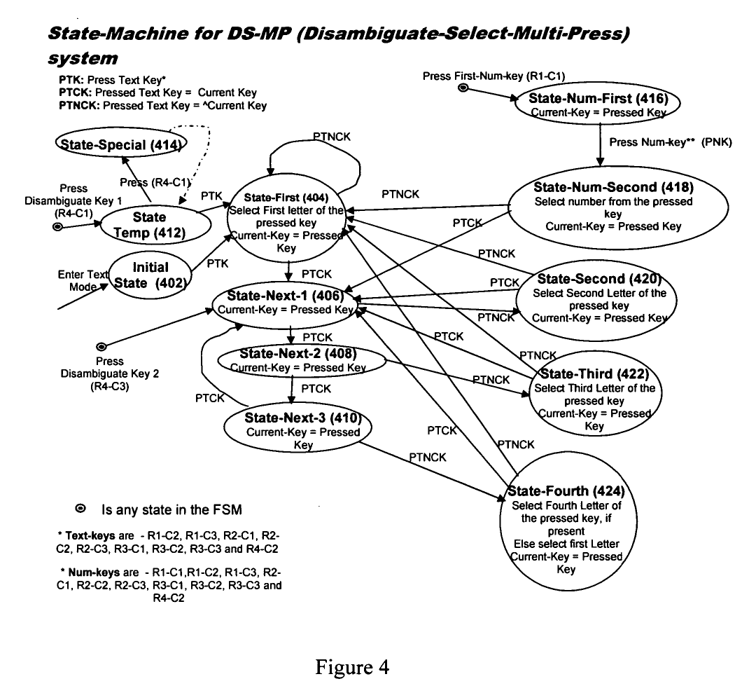

FIG. 4 shows one embodiment of the Disambiguate-Select-Multi-Press system in a state diagram form. Upon entering the text mode, the DS-MP system enters Initial State 402. From this state, if any of the Text Keys (R1-C2, R2-C3, R2-C1, R2-C2, R2-C3, R3-C1, R3-C2, R3-C3, R4-C2) are pressed the system enters State-first state 404. In this state, first letter of the pressed key is selected and outputted. If the current key is then pressed once, system enters state State-Next1 406, if it is pressed twice, system enters state State-next2 408, and if pressed thrice, system enters state State-Next3 410. Further pressing of the same key leads to system wrapping around between State-next1 406, State-next2 408 and State-next3 410. If a new Text key is pressed from one of State-next states, then either 2^{nd}, 3^{rd} or 4^{th} letter is chosen from the pressed key depending upon whether the earlier state was State-next1 406, State-next2 408 or State-next3 410 respectively. A press of the current key again transitions the state graph to State-next1 406. If a new Text key is pressed, then the graph goes back to State-first 404, which results in first letter getting selected.

R4-C1 , R4-C3 and R1-C1 are special keys to place the state machine into a State-Special 414. The state machine exits from which ever state it is in, and enter State-temp 412, State-next1 406 and State-Num-first 416 respectively. From State-temp 412, if a Text key is pressed, then again the first letter is selected, and the graph moves to State-first 404. If R4-C1 is pressed again, then graph enters a sequence of special characters. This sequence is not specific, and different sequences may be adopted by different system. R1-C1 bring the graph in state to allow selection of a number from the keys. From here if a Num-Key (R1-C1 though R3-C3 and R4-C2), then the number associated with that is selected. From state Num-First 416, upon a number key actuation, the state machine transitions to State Num-Second 418.

From State Next-1 406, the state machine transitions to State-Second 420, where the state machine can either transition back to State Next-1 406 or to State First 404. Similarly, from State Next-2 408, the state machine transitions to State First 404 or State Next-1 406. Further, from State Next-3 410, the state machine transitions to State First 404 or State Next-1 406.

In one implementation, a cancel/back-space function can be used to provide the effect of deleting the current character entry in progress, and putting state machine in Initial State 402.

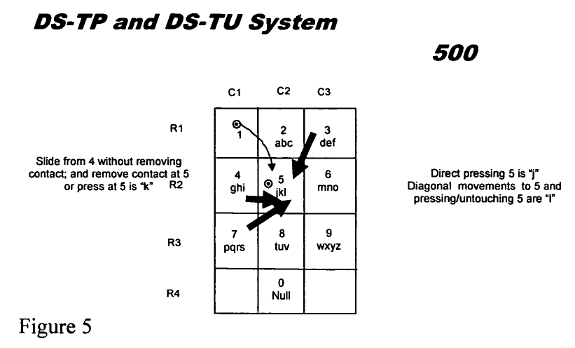

FIG. 5 shows examples of implementation of the proposed two-key scheme in a keypad with ability to differentiate between “touch” and “pressing” of the key. The touch keypad can detect various keys that are touched while sliding from one key to other or “Bi-level” touch keypad. Below are the two ways of constructing Bi-level touch pad.
1. In this case, the electronics below the keypad is capable to sensing presence of thumb/key over a key. It is also able to separate sense when the key is pressed, the second part if similar to the keypads of today. This type one is constructed by combining pressure sensing/switch based keys with touch keys.
2. Second way of constructing the bi-level keypad is as to use a touch keypad with one additional capability. In this touch screen, removing contact and re-establishing contact is meaningful. In this case, as a thumb/finger slides from one key to next, all the keys over which thumb/finger slides are recorded, and finally when the thumb/finger reaches destination key, the contact with the key is momentarily removed. This removal of the contact would provide additional input case. This is treated as the case of pressing key for in the earlier case. Since the proposed DS (Disambiguate-and-select) scheme provides disambiguation information first, for Bi-level touch keypads, instead of requiring multiple touches (multi-pressing), the character selection from the group of characters covered by a key, can be done by direction of approach to next key from the current key. Disambiguating based on the approach, vrs after pressing the destination key, has the advantage that it minimizes the thumb/finger movement. In this case, while moving a finger/thumb from one key to another, one can simply encode the information on which of the alphabet is to be selected simply by the path taken to the destination key. A direct contact (no touch prior to the destination key) implies that the first character of the character covered by the destination key is intended. If the destination key is approached from horizontal or vertical direction (i.e. the last touched key is to the left, right, top or bottom) it indicates the second character, and if the destination key is approached from diagonal direction (i.e. last touched key is from diagonal) then that input is taken as the 3^{rd} character. There are some keys with four characters e.g. (R3-C1 and R3-C3). For these exception cases, approaching the key from below direction (i.e. the last key touched is the key below) can be taken as 4th character.

To illustrate, one is entering “k” in the text mode, and keypad supports sliding over the keys. In this case “k” is represented by R2-C1→R2-C2, where→ indicates sliding motion, the first key is only “touched”, and the second key is “pressed” or “untouched”. When the user starts from R2-C1 and moves to R2-C2 without breaking the contact or pressing, and then removes contact or presses R2-C2, the system would indicate a selection of the 2^{nd} character of R2-C2 as the next character, which is “k”. Directly pressing, or touching/untouching R2-C2 would indicate the first character, which is “j”. R3-C1→R2-C2 and R1-C3→R2-C2, both indicate third character of R2-C2, which is “l”.

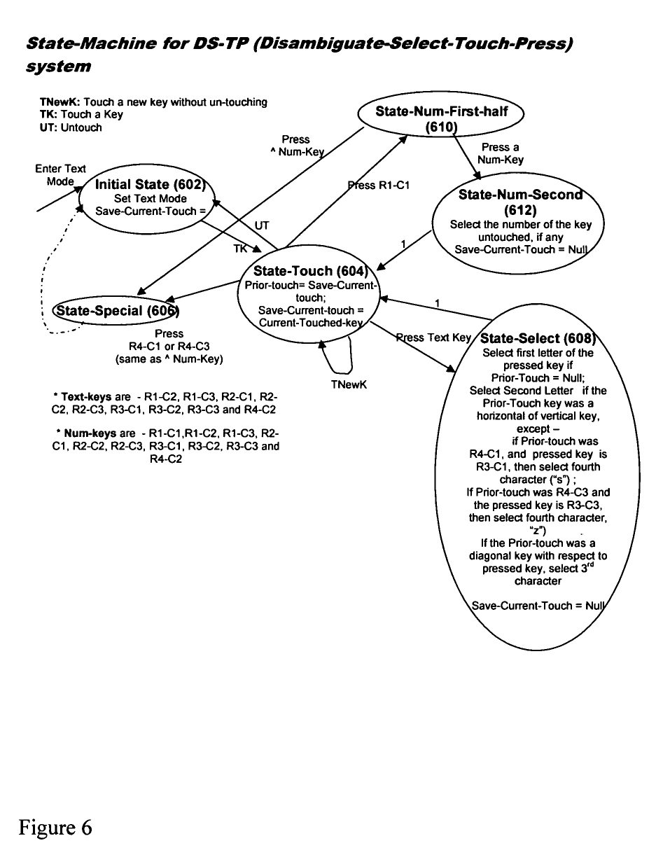

FIG. 6 shows the state machine implementation of Disambiguate-Select-Touch-Press (DS-TP) system. Upon entering the text mode, the graph enters Initial State 602. At this point no key has been touched in the text mode, so the Save-Current-key variable is initialized to “null”. After that as any key is touched, the system enters State-touch 604. From state 604, upon pressing the Special Keys (R4-C1 and R4-C3), the state machine transitions to State Special 606. The functions of the special keys are not defined here, and various combinations are possible. Also, there is an optional cancel/back-space button that is not described. This has the effect of deleting the current character entry in progress, and putting state machine in Initial State 602.

At this point, and all subsequent points, as different keys are touched (sliding of finger/stylus over the keys), system keeps track of the last key touched (Prior-touched-key) and the Current-touched-key. At some point a Current-touched-key is also pressed. The pressed key can belong to one of 3 categories of keys.
1. Textkey
2. Number Mode Key (R1-C1)
3. Special Keys (R4-C1 and R4-C3). Note that Special keys are the keys that are not part of the any number (0 through 9) keys.

If the pressed key is a Text key, and the prior-touched-key state is “Null”, the state machine transitions from state 604 to State Select 608 where the first letter is selected. If the prior-touch-key is either horizontal or vertical key to the pressed key, second letter is selected. There are two exceptions here. For case of R4-C1 touch followed by R3-C1 press, fourth character, “s”, is selected, and for R4-C3 touch followed by R3-C3 press, fourth letter of the key R3-C3, letter “z”, is selected. If the Prior-touch-key is diagonal to the pressed key, then 3^{rd} letter of the pressed key is selected. After letter selection, the system enters back into State-Touch 604, but with Save-Current-Key set to Null. This state is similar to entering State-Touch 604 from Initial State 602.

Again if R1-C1 is pressed once, then system enters State-Num 610-first-half. System can escape from here by going to one of the special function keys (R4-C1 and R4-C3). The state machine transitions from state 610 to State Num Second 612 by pressing a Num key which results in selecting the number on the key.

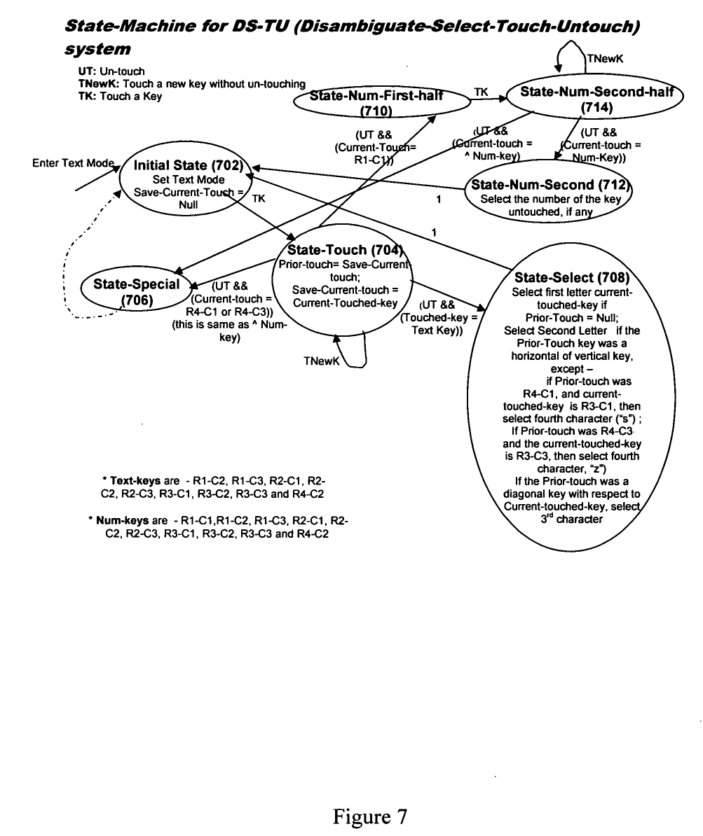

FIG. 7 shows the state machine implementation of Disambiguate-Select-Touch-Untouch (DS-TU) system. This system is similar to DS-TP system of FIG. 6, except in this case Un-touching of a key is taken as similar to “pressing” of the key in previous system. Upon entering the text mode, the graph enters State-initial 702. At this point no key has been touched in the text mode, so the Save-Current-key variable is initialized to “null”. After that as any key is touched, the system enters State-touch 704. At this point, and all subsequent points, as different keys are touched (sliding of fingers over the keys), system keeps track of the last key touched (Prior-touched-key) and the Current-touched-key). At some point a Current-touched-key is also Un-touched. The Un-touched key can belong to one of 3 categories of keys:
1. Text key—enters State Select 708
2. Number Mode Key (R1-C1)—enters states State Num First Half 710, State Num Second 712 and State Num Second Half 714
3. Special Keys (R4-C1 and R4-C3)—enters State Special 706. Special keys are the keys that are not part of the any number (0 through 9) keys.

If the Untouched key is a Text key, and Prior-touched-key state is “Null”, the first letter is selected. If the Prior-touch-key is either horizontal or vertical key to the pressed key, second letter is selected. There are two exceptions here. For case of R4-C1 touch followed by R3-C1 Un-touch, fourth character, “s”, is selected, and for R4-C3 touch followed by R3-C3 Un-touch, fourth letter of the key R3-C3, letter “z”, is selected. If the Prior-touch-key is diagonal to the pressed key, then 3^{rd} letter of the untouched key is selected. After letter selection, the system enters back into Initial State 702.

Again if R1-C1 is untouched once, then system enters State-Num-first-half. Upon touching of any key it enters State-num-second-half. The system can escape from this state when the user presses one of the special function keys (R4-C1 and R4-C3) or un-touches a Num key results in selecting the number on the key.

As mentioned before, the functions of the special keys are not defined here, and various combinations are possible. Also, a cancel back-space button can be pressed to delete the current character entry in progress, and puts the state machine in Initial State 702.

For touch keypad method, where keypad can differentiate between initial touch, continuous touch, and un-touch states, as outlined above, the key selection can be done before disambiguation step. An example of such a scheme would be that R2-C2→R2-C3 would indicate “k” as opposed to R2-C3→R2-C2. Similarly, in this scheme, R2-C2→R1-C3 indicates “l”, instead of R1-C3→R2-C2 or R3-C3→R2-C2 representing “l”. This scheme is referred to as Select-Disambiguate-Touch-Untouch (SD-TU) scheme.

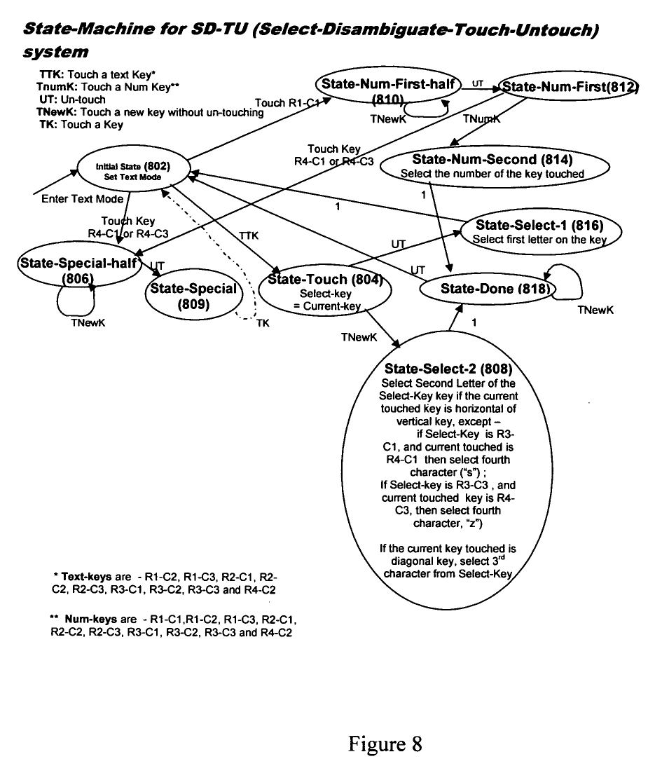

FIG. 8 shows an exemplary state diagram for a SD-TU scheme. In this scheme, there is no need to keep any history of the last touched key. Instead, at the Initial State 802, there are three categories of the keys that could be touched. These can include:
1. Text key
2. Number Mode Key (R1-C1)
3. Special Keys (R4-C1 and R4-C3). Note that Special keys are the keys that are not part of the any number (0 through 9) keys.

From Initial State 802, the machine transitions to State-Touch Select Key 804, from which the machine can transition to either State Select-1 816 upon untouching or State Select-2 808 upon touching a new key without untouching. From State Select 2 808, the system can transition to State Done 818, where it eventually transitions back to the Initial State 802. From the Initial State 802, the system can transition to State Num First Half 810 when the user touches R1-C1, and the system then transitions to State Num First 812 upon untouching. From State Num First 812, the system transitions to State Num Second 814 upon the user touching a new key without untouching the present key. From State Num Second 814, the system transitions to State Done 818 which then transitions to the Initial State 802. From the Initial State 802, the system can transition to State Special half 806 when the user touches one of the special keys. Upon untouching, the system transitions from State Special Half 806 to State Special Half B 809, which in turn transitions back to the Initial State 802.

The system handles the condition that if the key touched is a Text key, there are two possibilities to be handled: the touched key itself could be un-touched, or the finger/stylus slides to an adjacent key prior to un-touching of the key. If the touched key is itself untouched, first letter is chosen, else if the finger/stylus slides horizontally or vertically, then second character is chosen, except, touching R3-C1 and then sliding to R4-C1 is taken as the fourth character of R3-C1, which is “s”. Touching R3-C3 and then sliding to R4-C3 is taken as fourth character of R3-C3, which is “z”. Touching a Text key and then sliding diagonally to one of the keys, if the key is present, is taken as the 3^{rd} letter of the Key touched initially.

Touching of R1-C1, and then releasing at any other point, selects the number mode. Following this touching of any Number key selects the number of that key. If instead of number key, special keys R4-C1 or R4-C3 are selected, then system enters special character mode, which can be user defined. A cancel/back-space button can be used for deleting the current character entry in progress, and putting state machine in Initial State.

The above methods improve significantly inputting of text using the standard 4 rows×3 column matrix layout on the cell phones. The method or scheme also lends itself to evolving the keypad of cell phones to different layouts, while still allowing convenient inputting of the text with only a small number of keys. The method or scheme is well suited for working with both the standard pressure sensitive keypads as well as touch keypads. The scheme removes the time-out notion from a multi-press entry system while still minimizes any additional stylus (thumb/finger) movement. The method can work with conventional keypads or touch-sensitive keypads that can differentiate between “touch” and “press” or between “touch” and “untouch”.

While in the above mentioned scheme the meaning of any diagonal key touching, as well as most horizontal and vertical keys touching is kept same, the system can differentiate between up to 8 possible keys that can be touched prior to of after the key that is used for selection purpose. Of course, it is also possible to generalize this same concept to touching of more than one key before or after the selection key. Also, for illustration purposes, examples of English text data entry are used. However, the system is not limited to a particular language or character set.

The invention can be implemented in software or firmware. Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for entering data into a keypad having a plurality of keys, each key used to select one character from first, second, third or more characters designated for each key, the method comprising:
providing disambiguation information on a current key and
subsequently selecting a next key covering a desired character.

2. The method of claim 1, wherein the disambiguation information is provided through multiple presses of the current key.

3. The method of claim 1, wherein a lack of additional pressing of the current key implies a first character from the next key is selected.

4. The method of claim 1, comprising pressing the current key once to select a second character from the next key.

5. The method of claim 1, comprising pressing the current key twice to select a third character from the next key.

6. The method of claim 1, comprising pressing the current key thrice to select a fourth character from the next key.

7. The method of claim 1, comprising designating a key not belonging to the set of keys with a character-set to provide disambiguation information where the next key is the same as the current key.

8. The method of claim 1, comprising upon pressing the next key, providing a selected character and moving a cursor to a new display position.

9. The method of claim 1, comprising detecting a key stroke indicating repetition of the previous character.

11. The method of claim 1, comprising receiving data entry from a touch keypad capable of distinguishing between touching and pressing a key.

12. The method of claim 11, wherein the keypad has touch-sensing and key press detection capability.

13. The method of claim 11, wherein removing a touch from a key (un-touching a key) indicates selecting the key.

14. The method of claim 11, wherein touching and un-touching comprises two distinct events.

15. The method of claim 11, wherein a key touch immediately prior to pressing/untouching of another key indicates the character to be taken from the key is pressed/untouched.

16. The method of claim 11, wherein, only two possible characters are available to choose from a key, comprising touching any key immediately prior to pressing or untouching a subsequent key to select a second character associated with the subsequent key.

17. The method of claim 11, wherein at least three possible characters are available to choose from a key, comprising touching a key in either a horizontal or a vertical line immediately prior to pressing or untouching a subsequent key to select a second character associated with the subsequent key.

18. The method of claim 11, wherein at least three possible characters are available to choose from a key, comprising touching a key in a diagonal line immediately prior to pressing or untouching a subsequent key to select a third character associated with the subsequent key.

19. The method of claim 11, wherein the last key touched is R4-C1 key and wherein the subsequent pressed or untouched key is R3-C1 key, comprising selecting the fourth character associated with the R3-C1 key.

20. The method of claim 11, wherein the last key touched is R4-C3 key and wherein the subsequent pressed or untouched key is R3-C3 key, comprising selecting the fourth character associated with the R3-C3 key.

21. The method of claim 11, comprising differentiating up to one of eight possible keys that can be touched last prior to a selection key.

22. A method for entering data into a keypad having a plurality of keys, each key used to select one character from first, second, third or more characters designated for each key, the method comprising:
detecting as separate events a touching of a first touch key prior to any key being touched as a first event and a touching of a new key without untouching the keypad as a second event, and
selecting one of the characters based on the first touch key as a selected key and a subsequent touching of an adjacent key without untouching of the keypad as an index to determine the character on the selected key.

23. The method of claim 22, comprising selecting the first character of a selected key when untouching without touching an adjacent key.

24. The method of claim 22, wherein only two characters are available to select from a key, comprising selecting a second character associated with a select key by moving to any adjacent key without untouching the keypad.

25. The method of claim 22, wherein at least three characters are available to select from a key, comprising selecting a second character associated with a select key by moving a horizontal or vertical line to an adjacent key without untouching the keypad.

26. The method of claim 22, wherein at least three characters are available to select from a key, comprising selecting a third character associated with a select key by moving in a diagonal line to the an adjacent key without untouching the keypad.

27. The method of claim 22, wherein a first key touched prior to any other key is an R4-C1 key and wherein the subsequent key touched is a R3-C1 key, comprising selecting the fourth character associated with the R3-C1 key.

28. The method of claim 22, wherein a first key touched prior to any other key is an R4-C3 key and wherein the subsequent key touched, without untouching the keypad, is an R3-C3 key, comprising selecting the fourth character associated with the R3-C3 key.

29. The method of claim 22, comprising differentiating up to one of eight possible keys that can be touched after a selection key.

30. A system to receive data entry from a user, comprising:
a keypad having a plurality of keys, each key used to select one character from first, second, third or more characters designated for each key;
a processor coupled to the keypad having code to provide disambiguation information on a current key and subsequently selecting next key covering a desired character; and
a display coupled to the processor to render the desired character.

31. The system of claim 30, wherein the keypad detect as separate events a touching of a key, and subsequently untouching or pressing any key, comprising computer readable code to select one of the characters based on the key pressed or touched, the select key, and using the key prior to this key that was touched to index as to which of the characters is selected from the select key.

32. The system of claim 30, wherein the keypad detect as separate events a touching of a first touch key prior to any key being touched as a first event and a touching of a new key without untouching the keypad as a second event, comprising computer readable code to select one of the characters based on the first touch key as a selected key and a subsequent touching of an adjacent key without untouching of the keypad as an index to determine the character on the selected key.
